(19) United States
(12) Patent Application Publication
(10) Pub. No.: US 2008/0054507 A1
(43) Pub. Date: Mar. 6, 2008

(54) Manufacturing Miniature Structured Elements with Tool Incorporating Spacer Elements

(75) Inventors: Hurmat Rudmann, Unterlunkhofen (CH); Stephan Heimgartner, Luzern (CH); Susanne Westenhofer, Wettswil (CH); Markus Rossi, Jona (CH)

Correspondence Address: PROSKAUER ROSE LLP, ONE INTERNATIONAL PLACE, BOSTON, MA, 02110, US

(73) Assignee: Heptagon OY, Espoo (FI)

(21) Appl. No.: 11/943,472

(22) Filed: Nov. 20, 2007

Related U.S. Application Data
(63) Continuation-in-part of application No. 11/384,537, filed on Mar. 20, 2006.

(51) Int. Cl. B29D 11/00

(52) U.S. Cl. 264/2.7; 425/395

(57) ABSTRACT

A plurality of optical elements can be manufactured by replication. A replication tool can include a plurality of replication sections having negative structural features that define the shape of the plurality of optical elements and at least one first spacer portion. A replication material can be disposed between a substrate and the replication tool. The replication tool and the substrate can be moved so that a substantially flat surface portion of each first spacer portion rests against a layer of replication material remaining between the at least one first spacer portion and the substrate. The layer of replication material keeps the at least one first spacer portion spaced from the substrate. The replication material can be hardened to form the plurality of optical elements.

### CROSS-REFERENCE TO RELATED APPLICATION

This application is a continuation-in-part of U.S. patent application Ser. No. 11/384,537, filed Mar. 20, 2006, the disclosure of which is herein incorporated by reference in its entirety.

### FIELD OF THE INVENTION

The invention is in the field of manufacturing optical elements, in particular refractive optical elements and/or diffractive micro-optical elements, by means of a replication process that includes embossing or moulding steps.

### BACKGROUND OF THE INVENTION

A structured (or micro-structured) element can be manufactured by replicating/shaping (e.g., moulding, embossing or the like) a 3D-structure in a preliminary product using a replication tool. The replication tool can include a spacer portion protruding from a replication surface. A replicated micro-optical element is referred to as replica.

The spacer portions allow for an automated and accurate thickness control of the deformable material on the substrate. They can include “leg like” structures built into the tool. In addition, the spacers prevent the deformation of the micro optical topography since the spacers protrude further than the highest structural features on a tool.

A replica (e.g., a micro-optical element, a micro-optical element component, or an optical micro-system) can be made of epoxy, which can be cured—for example UV cured—while the replication tool is still in place. UV light curing is a fast process that allows for control of the hardening process.

The replication process can be an embossing process, where the deformable or viscous or liquid component of the preliminary product to be shaped is placed on a surface of a substrate, which can have any size. For example, it can have a small-size with a surface area corresponding to the area of only one or a few elements to be fabricated. As an alternative, the substrate can be wafer scale in size. ‘Wafer scale’ refers to the size of disk like or plate like substrates of sizes comparable to semiconductor wafers, such as disks having diameters between 2 inches and 12 inches. Then, the replication tool is pressed against this surface.

The embossing step stops once the spacer portions abut against the top surface of the substrate. The surface thus serves as a stop face for the embossing.

As an alternative, the replication process can be a moulding process. In a moulding process, in contrast, the tool having the spacer portions, e.g., leg-like structures, is first pressed onto the surface of a substrate to form a defined cavity which is then filled through a moulding process.

### SUMMARY OF THE INVENTION

The invention, in one embodiment, features a system and technique for manufacturing one or more optical elements (e.g., a micro-optical element). For example, a replication tool can include one or more first spacer portions separated from a substrate by a thin layer of replication material. The first spacer portion can be a so-called “floating spacer” because a flat surface portion of the first spacer portion can float over the substrate surface.

In one aspect, the invention features a method of manufacturing a plurality of optical elements by replication. A replication tool can include a plurality of replication sections having negative structural features that define the shape of the plurality of optical elements and at least one first spacer portion. A replication material can be disposed between a substrate and the replication tool. The replication tool and the substrate can be moved so that a substantially flat surface portion of each first spacer portion rests against a layer of replication material remaining between the at least one first spacer portion and the substrate. The layer of replication material keeps the at least one first spacer portion spaced from the substrate. The replication material can be hardened to form the plurality of optical elements. A force can be applied to move the replication tool and the substrate.

In another aspect, the invention features a replication tool for manufacturing a plurality of optical elements by replication from a replication material. The replication tool includes at least one negative structural feature defining the shape of the plurality of optical elements, and at least one first spacer portion adjacent the at least one negative structural feature, and at least one second spacer portion adjacent the at least one first spacer portion. The at least one first spacer portion has a substantially flat surface portion. The at least one second spacer portion is adapted to contact a surface of a substrate. The at least one first spacer portion defines a distance between the replication tool and the substrate so that the substantially flat surface portion of the at least one first spacer portion rests against a layer of replication material remaining between the first spacer portion and the substrate.

In still another aspect, the invention features a method of manufacturing a plurality of optical elements by replication. A replication tool includes a plurality of replication sections having negative structural features defining the shape of the elements. Each replication section includes a dome-shaped portion and a protruding flat portion surrounding the dome-shaped portion. The flat portion serves as a first spacer and defines a height of the optical elements. A replication material is disposed between a substrate and the replication tool. The replication tool and the substrate are moved so that the protruding flat portion rests against a layer of replication material remaining between the protruding flat portion and the substrate, and at least one second spacer portion contacts a surface of the substrate. The replication material is hardened to form the plurality of optical elements. The replication tool is removed, and the substrate can be separated to form discrete optical elements.

In other examples, any of the aspects above, or any apparatus or method described herein, can include one or more of the following features. The replication material can be in at least one of a plastically deformable, viscous, or liquid state. Each optical element can be a refractive lens.

The distance between the flat surface portion and the substrate and/or the thickness of the layer of the replication material can be determined by the balance between the magnitude of the force applied and the cohesive forces within the replication material. Depending on the properties of the replication material, the adhesive forces between the replication material and the substrate and/or tool can determine the distance. Furthermore, the second spacer portions (“contact spacers”), which protrude higher on the replication tool than the first spacer portions and which can abut upon the substrate surface during replication, can determine the distance. The weight of the replication tool or the weight of the substrate can be correlated to the amount of force applied. Active distance adjusters and/or controllers (such as a mask aligner) or other means can be used to determine the distance.

In some embodiments, the distance between the first spacer portions and the substrate is constrained by the relative height of the second spacer portions with respect to the first spacer portions. This provides even higher precision, with the second spacer portions absorbing at least part of the force between the tool and substrate and determining a reference height of the first spacer portions with respect to the substrate, and the first spacer portions—potentially being close to the element to be replicated—precisely defining local height differences. Also, the first spacer portions (via the replication material) may if necessary absorb a remainder of the force and settle at a predetermined distance from the substrate. The first spacer portions also allow the tool to adapt to minor irregularities of the planarity of the substrate.

The replication material can be applied to the tool or the substrate without covering a second spacer support area, such that no replication material is present between the second spacer portions and the substrate after the tool is moved against the substrate. That is, both the tool and the substrate can have a second spacer support area—for the tool, this is the contact area of the tool itself, for the substrate it is the area on which the contact area of the tool is placed.

Preferably, in the direction of movement of the tool against the substrate, the height of the first spacer portions and the height of the second spacer portions differs by a element spacer height difference. In certain embodiments, the element spacer height difference is in the range of about 1 to about 500, preferably about 5 to about 30, ideally about 7 to about 15 micrometers.

The second spacer portions can have one or more flat surface portions that are parallel to the substrate. The second spacer portion(s) can contact a surface of the substrate when the first spacer portions rest against the layer of replication material.

The first spacer portions can be arranged so that the dicing lines—the lines where after replication, hardening and removing the replication tool the substrate with hardened replication material is separated into individual parts, e.g. chips—are at the positions where first spacer portions are arranged. Therefore, along the dicing lines, only a comparably thin layer of replication material—the base layer—remains. This can prevent delamination of the replication material from the substrate. In some embodiments, after hardening the replication material, the plurality of optical elements are separated along dicing lines, which can be along lateral positions of the substrate where during replication the at least one first spacer portion was located.

In some embodiments, the first spacer portions and second spacer portions define a height of the elements above the substrate: This is possible since the final location of the tool over the substrate, and therefore the height of the structured surface of the elements with respect to substrate, can be precisely controlled. Preferably, the element is a refractive optical element and the height of the elements above the substrate is predetermined in accordance with required optical properties of the element. This feature is special for refractive elements, such as refractive lenses, where the relation or distance between the top and bottom surfaces plays a role, as opposed to diffractive elements, where the optical function is mainly defined by the function of the structured surface (e.g., a diffraction pattern) defined by the structure of the replication section.

The replication material can be dispensed in a single dispense operation (e.g., as a single blob) or as a few single dispense operations—each providing replication material for a plurality of replication sections—on the substrate or on the replication tool for the entire tool-scale replication. The second spacer portions, if used, can be tool-scale spacer portions. The second spacer portions can be arranged at the periphery of the tool surrounding the replication sections. The second spacer portions then do not comprise or define any replication sections.

In some embodiments, the plurality of negative structural features can be interspersed with a plurality of first spacer portions. The at least one second spacer portion can be arranged at a periphery of the replication tool so that the at least one second spacer portion does not define the replication area.

In certain embodiments, the replication material can be dispensed in an array of individual, separate dispense operations (e.g., blobs). A potentially pre-determined volume of replication material is applied to an array of points, corresponding the location of the parts to be separated later by dicing, and each blob of replication material can be confined to a part. Each part comprises one element to be fabricated or a group of elements (e.g., about 4 elements). There can be areas between the parts that are free of replication material. For example, the second spacer portions can be distributed over the entire replication tool. For example, each part may comprise a second spacer portion. No replication material need be present between the at least one second spacer portion and the substrate after the replication and the substrate are moved.

Dispensing in an array of individual replication materials portions can provide the replication sections with an optimal amount of replication material and reduces the chance of defects. Further details of this aspect are described in a co-pending application “Method and tool for manufacturing optical elements” by the same applicants and having the same filing day as the present application.

In some embodiments, prior to moving the replication tool and the substrate against each other, the replication material is applied as a contiguous amount of replication material covering a plurality of negative structural feature. In some embodiments, the replication material is applied as a series of discrete portions, each of which is confined to a lateral position corresponding to a respective negative structural feature.

The element produced typically is a refractive or diffractive optical element—such as a lens, but also can have a micromechanical function in at least one region.

The tool comprises a plurality of replication sections, thus allowing for the simultaneous manufacturing of an array of elements on a common substrate. This common substrate can be part of an opto-electronic or micro-opto-electronic assembly comprising optical and electronic elements produced on a wafer scale and later diced into separate parts.

In certain embodiments, the step of applying the force is accomplished by giving the tool a predetermined weight and placing the tool above the substrate, or by giving the substrate a predetermined weight and placing the substrate above the tool, and letting gravity do the pressing. In this manner, the pressing force can be controlled very precisely. Even if no second spacers are present or, where peripheral second spacer portions are present, the stiffness of the replication tool is not sufficient to precisely locally define the z-dimension. The resulting distance between the first spacer portions and the substrate can be controlled very precisely and is reliably repeatable.

An amount of force to be used to move the replication tool can be determined. The amount of force can be correlated with an equilibrium of forces between the surface tension of the replication material and the force applied at the first spacer portion so that the first spacer portion can define the distance between the replication tool and the substrate. The replication tool can be provided with a predetermined weight that correlates to the amount of force so that the replication tool moves against the replication material under the force of gravity. The substrate can be provided with a predetermined weight that correlates to the amount of force so that the substrate moves against the replication material under the force of gravity.

In some embodiments, the height of the second spacer portions, in a direction of movement of the replication tool against a substrate, is greater than the height of the first spacer portions. Each first spacer portion can be arranged around a negative structural feature. The negative structural feature and the first spacer portion can define a replication area, and the at least one second spacer portion can be arranged around the periphery of the replication area.

In certain embodiments, each replication section has an associated first spacer portion surrounding it or being arranged around the replication section. The first spacer portion thus defines the shape or the boundary of a periphery of the element created by the replication section.

In some embodiments, the total area covered by the first spacer portions is between about 0.1% and about 50%, preferably between about 0.5% and about 20%, especially preferred between about 2% and about 10% of the total area of the tool covering the substrate. As a general rule, if the area covered by the first spacer portions is sufficiently large, and exceeds a certain limit, then second spacer portions need not be used. The exact value of said limit can be determined by the flow properties of the replication material and on the force with which the tool is pressed against the substrate.

In various embodiments, the total area covered by the second spacer portions can be between about 1% and about 50%, preferably between about 5% and about 25%, especially preferred between about 10% and about 20% of the total area of the tool covering the substrate.

In some embodiments, the total area covered by the second spacer portions can be between about 10% and about 1000%, preferably between about 25% and about 400%, especially preferred between about 50% and about 200% of the total area covered by the first spacer portions.

The flat portion surrounding the dome shaped portion can be immediately adjacent the dome shaped portion.

Further preferred embodiments are evident from the dependent patent claims. Features of the method claims may be combined with features of the device claims and vice versa.

### BRIEF DESCRIPTION OF THE DRAWINGS

The subject matter of the invention will be explained in more detail in the following text with reference to preferred exemplary embodiments, which are illustrated in the attached drawings, which schematically show:

FIG. 1: a cross section through a replication tool;

FIG. 2: an elevated view of a replication tool;

FIG. 3: an elevated view of another replication tool;

FIGS. 4-6: steps of a replication process;

FIGS. 7-10: further tools and replication steps; and

FIG. 11: a flow diagram of a replication process.

### DETAILED DESCRIPTION OF THE INVENTION

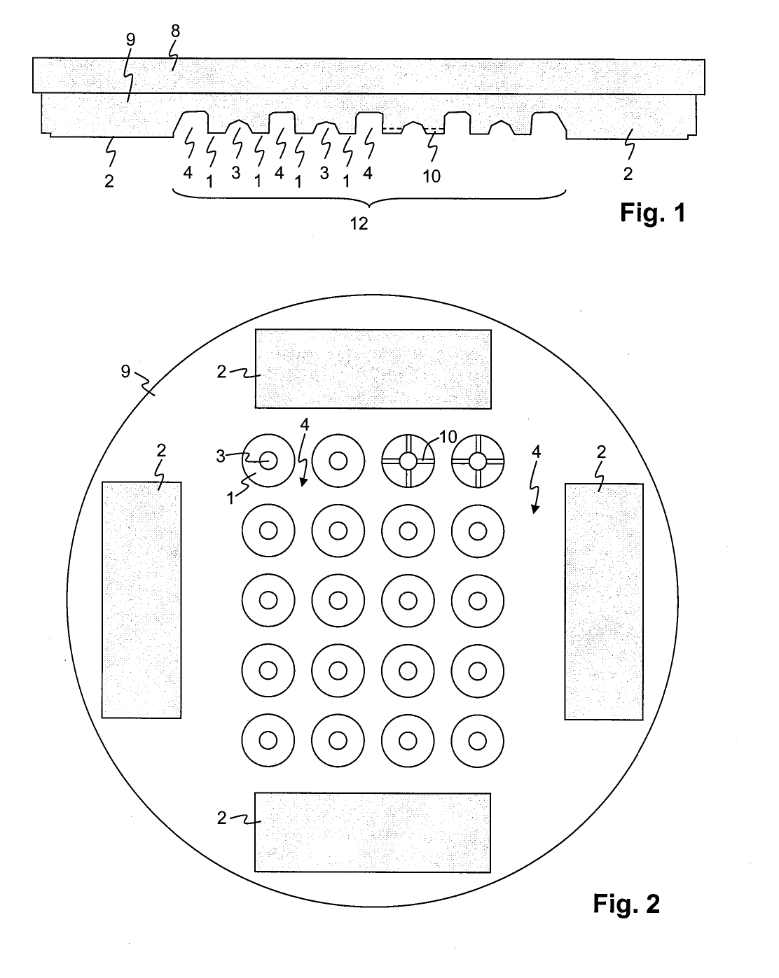

FIG. 1 schematically shows a cross section through a replication tool 9. The tool 9 comprises a plurality of replication sections 3, e.g., negative structural features defining the shape of elements 6 to be created with the tool 9. Each of the replication sections 3 is partially or completely surrounded at its periphery by a first spacer portion or local or element spacer portion 1. The area covered by the replication sections 3 and first spacer portions 1 interspersed in this manner is called the replication area 12. The replication tool may further comprise a rigid back plate 8 to make it dimensionally stiff on a large scale.

The first spacer portion 1 on the one hand serves to define the shape or the boundary of the element 6 in the region close to the substrate 7, and on the other hand to define the height of the element 6 with respect to a base layer. Depending on the dimensional stability of the replication tool 9, it may further serve for defining the height of the element 6 with respect to the substrate 7. That is, the first spacer portion 1 comes to rest against the substrate 7 or at a controllable distance from the substrate 7. The latter distance, the base layer thickness, here also called “element spacer height difference”, is determined by the vertical extension of the second spacer portions 2 relative to that of the first spacer portion 1.

In this text, for the sake of convenience, the dimension perpendicular to the surface of the substrate 7, which comprises an essentially flat surface—is denoted as “height”. In actual practice, the entire arrangement may also be used in an upside down configuration or also in a configuration where the substrate surface is vertical or at an angle to the horizontal. The according direction perpendicular to the surface is denoted z-direction. The terms “periphery”, “lateral” and “sides” relate to a direction perpendicular to the z-direction. The terms “periphery” and “sides” of the element are thus understood when looking at the substrate from a direction perpendicular to the essentially flat substrate. The element covers a part of the substrate, and the surrounding other parts of the substrate, i.e. the region of space adjacent to both the substrate and the functional part of the element, in particular under the first spacer portions, may be covered with the replication material, without interfering with the function of the element.

The replication tool preferably is made of materials with some elasticity, for example PDMS (polydimethylsiloxane) or another elastic material. This results in a conformal thickness control of the element 6 produced, even if the substrate surface, on which the process is executed is not perfectly planar, or if the replication tool is not perfectly planar.

FIG. 2 shows an elevated view of a replication tool. Individual replication sections 3 are shown surrounded by first spacer portions 1. The first spacer portions 1 can each surround the replication section 3 in an unbroken circle, or can comprise spill or overflow channels 10 that make it easier for the replication material 5 to flow into areas or spill volumes (overflow volumes) 4. A number of separate second spacer portions 2 is arranged around the array of replication sections 3, at the periphery of the tool 9.

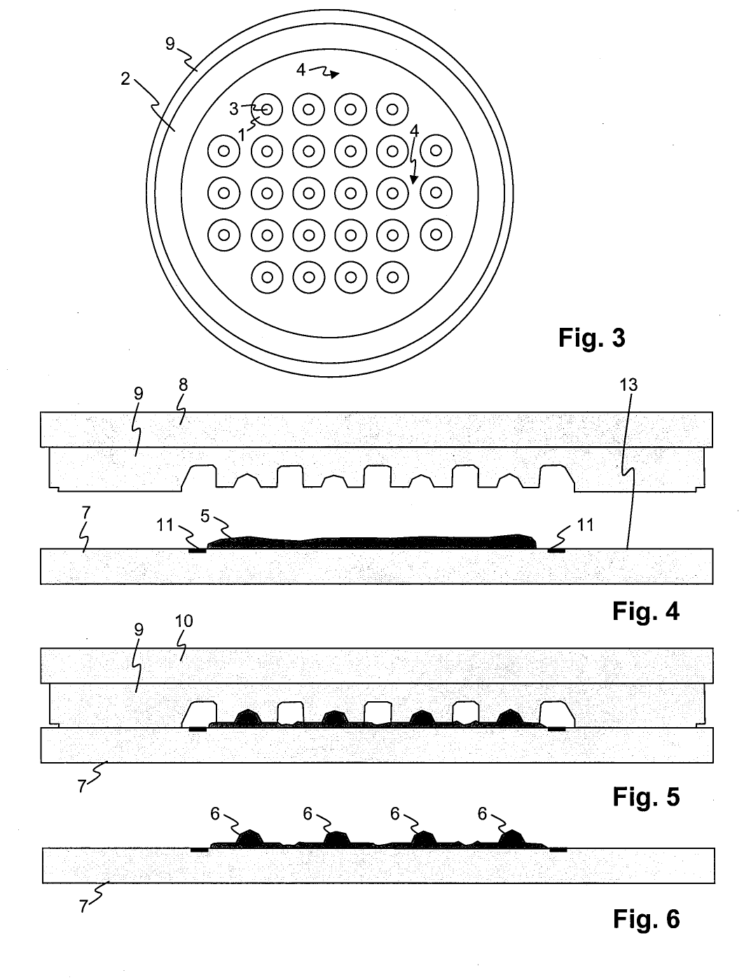

FIG. 3 shows an elevated view of another replication tool, in which a single second spacer portion 2 forms a ring around the grid of replication sections 3.

The tool 9 is preferably adapted to be used in wafer-scale processing, i.e. the substrate containing the array of replication sections may be disc-shaped. Thus, the diameter of the tool 9 preferably lies in a range from 5 cm to 30 cm. Wafer-scale combination of manufacturing with micro-electronics is possible, as is for example disclosed in WO 2005/083789 by the same applicant, herewith incorporated by reference in its entirety.

FIGS. 4-6 schematically show steps of a replication process involving a single dispense operation of replication material: In FIG. 4, the replication material 5 is applied to a substrate 7, and the tool 9 is positioned over the substrate 7. The second spacer portions 2 are positioned opposite corresponding second support areas 13 on the substrate 7. The replication material 5 can be an epoxy in a plastically deformable or viscous or liquid state. Preferably, the replication material 5 is applied only to areas of the substrate 7 which do not come into contact with the second spacer portions 2, i.e. not to the second support areas 13. The same holds when the arrangement is operated in an inverted configuration, with the substrate 7 on top of the tool 9, and the replication material 5 applied to the tool 9. Guiding elements for controlling the relative horizontal displacement and/or the downward movement of the tool 9 can be used.

In some embodiments, for example, the case in which the replication material 5 is applied to the substrate 7, the substrate 7 or the replication tool comprises a flow stopping section 11 with flow stopping means for preventing the replication material 5 from flowing onto the areas that are to come into contact with the second spacer portions 2. Flow stopping means on the substrate may be mechanical means such as ridges on or troughs in the substrate 7, or a mechanical or etching treatment that reduces the wetting capability of the substrate 7. Alternatively or in addition, such stopping means may effected by using a different material for the flow stopping section 11 of the substrate 7, or applying a chemical to said section, to reduce the wetting property of the substrate 7. Flow stopping means on the replication tool may include discontinuities such as edges preventing the replication material to certain areas by way of capillary forces and/or surface tension. In addition or as an alternative to the flow stopping means of the substrate and/or the replication tool, the flow may also be confined by way of controlling the dynamics, i.e. by making sure the second spacer portions 2 abut the substrate before the replication material arrives at the second support areas.

In another preferred embodiment of the invention, the first spacer portions 1 do not surround every replication section 3, but are e.g. separate pillars dispersed over the replication area 12. In this manner, a certain area of the substrate 7 may remain covered with a thicker section of the replication material 5 that is not functional, as compared to the elements 6.

In FIG. 5, the tool 9 has been moved against the substrate 7. The force driving this movement is preferably only the gravity acting on the tool 9. Thus, the weight of the tool 9, including the back plate 8 and optionally an additional mass, defines the force with which the tool 9 is pressed against the substrate 7. This allows a very precise control of the force, and of any elastic deformation of the tool 9 that may take place. The replication sections 3 are filled with replication material 5, and also the spill volumes are at least partially filled by replication material 5.

The second spacer portions 2 touch the substrate 7 without any replication material 5 in between, such that most of the weight of the tool 9 rests on the second spacer portions 2. The first spacer portions 1 are separated from the substrate 7 by the element spacer height difference, the resulting volume being filled with replication material 5.

The ideal element spacer height difference is chosen according to geometrical and thermomechanical constraints. The height difference determines the thickness of a layer of replication material underneath the floating spacers, the so-called base layer. This thickness can either be given by the design of the element or by the specifications given due to thermomechanical properties. As an example, it may be required that the base layer thickness is below 15 μm to avoid delamination during the dicing process, as explained further below.

The first spacer portion 1 can be spaced from the substrate 7 because an equilibrium of forces can exist between the surface tension of the replication material 5 and the force of gravity pushing the tool 9 and the substrate 7 together. The first spacer portion 1 can rest against the replication material 5 because the replication material 5 applies a force to counter the force applied by the tool 9 against the replication material 5. The counterbalancing of forces can determine the distance between the tool 9 and the substrate 7, or the thickness of the layer of replication material 5 at the flat spacer portions of the tool 9.

The replication material 5 can be hardened by thermal or UV or chemical curing.

In FIG. 6, the tool 9 has been removed from the substrate 7, leaving the hardened elements 6 on the substrate 7. Further processing depends on the nature and the function of the elements 6, i.e. the elements 6 may be separated from the substrate 7 or remain on the substrate 7 for further steps in a wafer-scale production process and later dicing into separate parts.

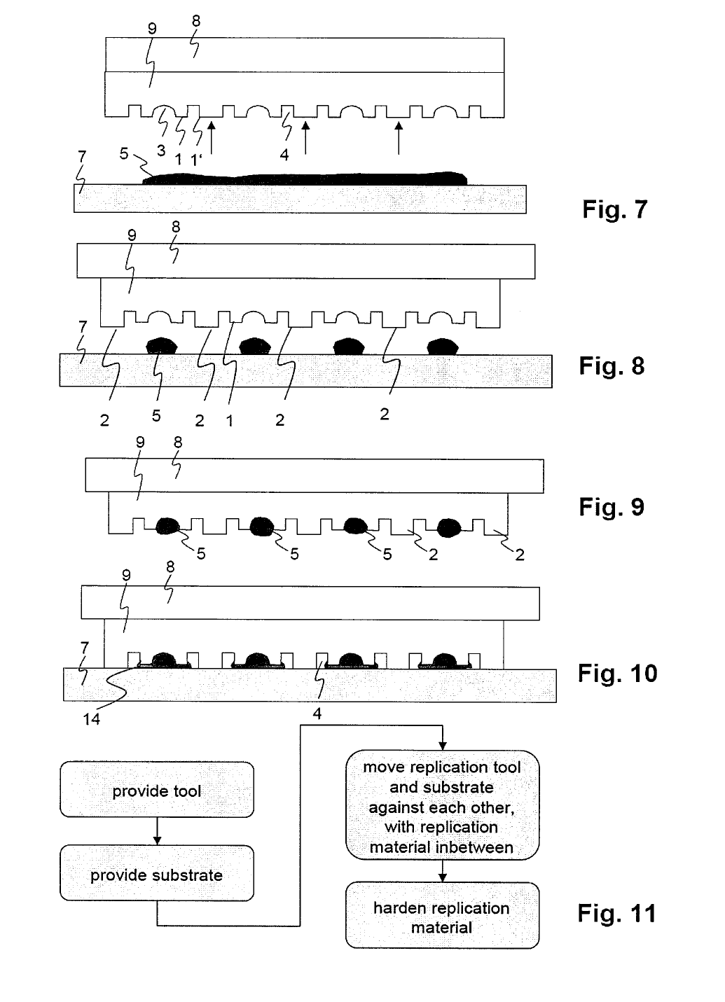

The replication tool 9 of FIG. 7 does not comprise any contact spacers. First spacer portions 1, 1′ surround the replication sections 3 but are also arranged between the parts which comprise at least one replication section. The region between the parts of the array is for example where after replication the dicing lines are chosen to lie. In FIG. 7, the corresponding locations on the tool are indicated by arrows. By way of the first spacer portions 1′ in the region between the parts only the thin base layer of replication material remains. This may be advantageous during the dicing process, where delaminating may occur for too thick layers of replication material. A method of manufacturing an optical element using a method that is particularly advantageous concerning the dicing process is described in U.S. patent application Ser. No. 11/384,558 “Manufacturing Optical Elements” by Rudmann and Rossi filed on the same day as the present application, which is herein incorporated by reference.

The replication tool shown in FIG. 8 comprises first spacer portions 1 surrounding the replication sections and further comprises second spacer portions 2 distributed over the tool. Such a replication tool is particularly suited for “array replication” where the replication material is dispensed in an array like manner in a plurality of blobs to the points where the optical elements are to be created. In the shown example, the replication material 5 is dispensed on the substrate.

The replication material 5 could also be dispensed to the tool, namely into the cavities which constitute the replication sections. This is shown in the FIG. 9 (only the tool, is shown without the substrate, the substrate does, before meeting the tool, for example not comprise any replication material). This principle of dispensing the replication material on the tool applies to all embodiments of the invention described herein, i.e. tools with and without second spacers, with distributed or with concentrated second spacers, etc.

FIG. 10 shows the situation during replication, after the replication tool 9 and the substrate 7 according to e.g. FIG. 8 or FIG. 9 have been moved against each other. During replication, the second spacer portions 2 abut the surface of the substrate, whereas there can be replication material underneath the first spacer portions 1, as illustrated in FIG. 9. Depending on the accuracy by which the replication material volume is determined, replication material may be displaced into the overflow volume 4 and for example form a bulge 14 along an outer edge of the first spacers.

FIG. 11 shows a flow diagram of replication process.

While the invention has been particularly shown and described with reference to specific embodiments, it should be understood by those skilled in the art that various changes in form and detail may be made therein without departing from the spirit and scope of the invention as defined by the appended claims.

What is claimed is:

1. A method of manufacturing a plurality of optical elements by replication, comprising:
providing a replication tool comprising (i) a plurality of negative structural features that define the shape of the plurality of optical elements and (ii) at least one first spacer portion;
disposing a replication material between a substrate and the replication tool;
applying a force to move the replication tool and the substrate toward each other to cause a substantially flat surface portion of each first spacer portion to rest against a layer of replication material remaining between the at least one first spacer portion and the substrate, the layer of replication material keeping the at least one first spacer portion spaced from the substrate;
hardening the replication material to form the plurality of optical elements.

2. The method of claim 1 further comprising:
determining an amount of force to be used to move the replication tool, the amount of force correlated with an equilibrium of forces between the surface tension of the replication material and the force applied at the at least one first spacer portion so that the at least one first spacer portion defines the distance between the replication tool and the substrate.

3. The method of claim 1 further comprising:
determining an amount of force to be used to move the replication tool; and
providing the replication tool with a predetermined weight that correlates to the amount of force so that the replication tool moves against the replication material under the force of gravity.

4. The method of claim 1 further comprising:
determining an amount of force to be used to move the substrate; and
providing the substrate with a predetermined weight that correlates to the amount of force so that the substrate moves against the replication material under the force of gravity.

5. The method of claim 1 wherein the replication tool further comprises at least one second spacer portion that contacts a surface of the substrate when the first spacer portions rest against the layer of replication material.

6. The method of claim 5 further comprising a replication area defined by the plurality of negative structural features interspersed with a plurality of first spacer portions, the at least one second spacer portion arranged at a periphery of the replication tool so that the at least one second spacer portion does not define the replication area.

7. The method of claim 5 further comprising applying the replication material to at least one of the replication tool and the substrate so that substantially no replication material is present between the at least one second spacer portion and the substrate after the replication and the substrate are moved.

8. The method of claim 5 wherein, in a direction of movement of the replication tool against the substrate, the height of the at least one first spacer portion and the height of the at least one second spacer portion differs by an element spacer height difference of about 5 micrometers to about 30 micrometers.

9. The method of claim 1 further comprising, prior to moving the replication tool and the substrate against each other, applying the replication material as a contiguous amount of replication material covering a plurality of negative structural feature.

10. The method of claim 1 further comprising, prior to moving the replication tool and the substrate against each other, applying the replication material as a series of discrete portions, each discrete portion confined to a lateral position on the substrate corresponding to a respective negative structural feature.

11. The method of claim 1 further comprising, after hardening the replication material, separating the plurality of optical elements along dicing lines, wherein the dicing lines are along lateral positions of the substrate where during replication the at least one first spacer portion was located.

12. A replication tool for manufacturing a plurality of optical elements by replication from a replication material, the replication tool comprising:
at least one negative structural feature defining the shape of the plurality of optical elements;
at least one first spacer portion adjacent the at least one negative structural feature, the at least one first spacer portion having a substantially flat surface portion; and
at least one second spacer portion adjacent the at least one first spacer portion, the at least one second spacer portion adapted to contact a surface of a substrate, the at least one first spacer portion defining a distance between the replication tool and the substrate so that the substantially flat surface portion of the at least one first spacer portion rest against a layer of replication material remaining between the first spacer portion and the substrate.

13. The replication tool of claim 12 wherein the height of the at least one second spacer portion is greater than the height of the at least one first spacer portion.

14. The replication tool of claim 12 wherein each first spacer portion is arranged around a negative structural feature.

15. The replication tool of claim 14 wherein the negative structural feature and the first spacer portion define a replication area, and the at least one second spacer portion is arranged around the periphery of the replication area.

16. The replication tool of claim 12 wherein the total area covered by the at least one first spacer portion is between 0.5% and 20% of the total area of the replication tool covering the substrate.

17. The replication tool of one of claim 12 wherein the total area covered by the at least one second spacer portion is between 5% and 25% of the total area of the replication tool covering the substrate.

18. A method of manufacturing a plurality of optical elements by replication, comprising:
providing a replication tool comprising a plurality of replication sections having negative structural features defining the shape of the elements, each replication section comprising a dome-shaped portion and a protruding flat portion surrounding the dome-shaped portion, the flat portion serving as first spacer and defining a height of at least one optical element;
disposing a replication material between a substrate and the replication tool;
moving the replication tool and the substrate so that (i) the protruding flat portion rests against a layer of replication material remaining between the protruding flat portion and the substrate and (ii) at least one second spacer portion contacts a surface of the substrate;
hardening the replication material to form the plurality of optical elements;
removing the replication tool; and
separating the substrate to form discrete optical elements.

19. The method of claim 18 wherein the flat portion surrounding the dome-shaped portion is immediately adjacent the dome-shaped portion.

20. The method of claim 18 wherein each discrete optical element comprises a refractive lens.
